(19) United States
(12) Patent Application Publication
(10) Pub. No.: US 2018/0122001 A1
(43) Pub. Date: May 3, 2018

(54) SOCIAL EVALUATION OF CREDITWORTHINESS SYSTEM AND METHOD

(71) Applicant: International Business Machines Corporation, Armonk, NY (US)

(72) Inventors: KAMAL BHATTACHARYA, NAIROBI (KE); Abdigani DIRIYE, NAIROBI (KE); ANDREAS KIND, Kilchberg (CH); TIMOTHY KOTIN, NAIROBI (KE); ERIC MIBUARI, NAIROBI (KE)

(21) Appl. No.: 15/336,756

(22) Filed: Oct. 27, 2016

(51) Int. Cl. G06Q 40/02

(52) U.S. Cl. CPC G06Q 40/025

(57) ABSTRACT

A system and method are provided for implementing a credit-worthiness recommendation system based on social capital. Recommenders are nominated by a user of the system, and the recommenders are queried to provide quantified creditworthiness information about the user.

### BACKGROUND

In embodiments, the technical field of the invention is a method and system to implement a credit-worthiness recommendation system based on social capital.

Despite advances in technology, banking remains an industry built on social capital and human-human interactions. Often the interpersonal information obtained from social interactions is as important as transactional histories (i.e., impersonal credit scores) in determining whether a loan applicant will meet repayment targets. However, transaction histories are far easier to quantify and tabulate, and are therefore typically the primary information or the only information used in determining creditworthiness. It is known from studies that basing financial information on community knowledge leads to more accurate identification of those individuals requesting loans.

Methods and systems for using technology in improving efficiencies in banking processes have been developed in recent years. For example, systems are known allowing people to use their online social connections to build their creditworthiness and access local financial services. There exists a need, however, to improve the ability of banking systems to incorporate non-traditional data into the loan making process.

### SUMMARY

In an aspect is a method comprising: receiving, by a server on a network, a user loan request, wherein the loan request specifies a recommender on the network; receiving, by the server via the network, creditworthiness information for the user from the recommender; determining a creditworthiness rating for the user based on the obtained creditworthiness information; comparing the creditworthiness rating to a threshold; and initiating an automatic loan process using the creditworthiness rating to determine at least in part a loan factor when the creditworthiness rating meets or exceeds the threshold. In embodiments:

the user loan request is generated by a user device configured to communicate with the network;

the user loan request is generated by a computer according to a non-digital user application;

the network comprises a cellular network and wherein the user loan request is generated by a user device configured to communicate with the cellular network;

the network comprises a data network and where the user loan request is a digital representation of a non-digital user application;

the network comprises a data network and wherein the user loan request is generated using a computer attached to the network;

the method further comprises automatically notifying the recommender of the loan request via the network prior to receiving creditworthiness information from the recommender;

the method further comprises automatically notifying the recommender of the loan request and further comprises prompting the recommender to facilitate entry of creditworthiness information by the recommender;

the creditworthiness information comprises information selected from loan repayment history, character reference, and repayment capacity;

the creditworthiness information is selected from a single numerical rating, a binary rating, an unformatted textual response, and/or a selection from a number of labeled choices;

the creditworthiness information received by the server is transmitted by the recommender from a mobile phone (e.g., a dedicated application on a mobile phone, or USSD or SMS messages);

the determined creditworthiness rating is based in part on a plurality of obtained creditworthiness information received from a plurality of recommenders;

the determined creditworthiness rating is based in part on a plurality of obtained creditworthiness information received from a plurality of recommenders, and in part on a stored credit history of the user;

the initiating an automatic loan process comprises instructing an automated loan system to process the loan request;

the loan factor is selected from a loan amount, an interest rate, and a repayment schedule;

the creditworthiness information is received in digital form via the network (e.g. USSD, SMS, email, web, etc.);

the loan request specifies a plurality of recommenders on the network and wherein the method further comprises receiving, by the server via the network, creditworthiness information for the user from each of the plurality of recommenders;

the method further comprises assigning a score to the recommender;

the method further comprises assigning a score to the recommender, wherein the score is dynamically updated based on a user performance factor over time, (wherein the user performance factor is established based on loan repayment history, loan frequency, loan value, etc., and wherein there are disincentives for false or fraudulent recommendations—reduction in the score of the recommender, etc., and wherein the are incentives for true positive recommendations including increases in the score, etc.);

the method further comprises assigning a tally to the recommender, and wherein receiving creditworthiness information for the user from the recommender results in a reduction in the tally of the recommender;

the method further comprises digitally constructing a structure comprising the recommender and optionally a plurality of additional recommenders;

the method further comprises digitally constructing a hierarchical structure comprising the recommender and optionally a plurality of additional recommenders, wherein each recommender is assigned a tally, and wherein the method further comprises relating the hierarchical structure to the user, and further comprises altering a tally for a recommender within the hierarchical structure based on a user performance factor; and

the method further comprises automatically notifying the recommender of the loan request and further comprises prompting the recommender to facilitate entry of creditworthiness information by the recommender.

In an aspect is a system comprising a server, the server comprising a processor and a memory coupled to the processor, the memory configured to store program instructions executable by the processor to cause the computer system to carry out the method as above.

In an aspect is a system comprising a server, the server comprising a processor and a memory coupled to the processor, the memory configured to store program instructions executable by the processor to cause the computer system to: receive a loan request from a user, wherein the loan request specifies a recommender on the network; receive creditworthiness information for the user from the recommender; determine the users creditworthiness based on the obtained creditworthiness information; comparing the creditworthiness rating to a threshold; and initiate an automatic loan process using the user's creditworthiness rating to determine a loan factor when the creditworthiness rating meets or exceeds the threshold. In embodiments:

the creditworthiness information received by the server is transmitted by the recommender from a mobile phone using USSD or SMS;

the creditworthiness information received by the server is transmitted by the recommender from a dedicated application on a mobile phone;

the program instructions further cause the computer system to automatically notify the recommender of the loan request via the network prior to receiving creditworthiness information from the recommender;

the creditworthiness information received by the server is transmitted by the recommender from a mobile phone using USSD, SMS, or a dedicated application on the mobile phone;

the network comprises a cellular network and the user loan request is generated by a user device configured to communicate with the cellular network, and wherein the loan request specifies a plurality of recommenders on the network and the system is further configured to receive, by the server via the network, creditworthiness information for the user from each of the plurality of recommenders;

the program instructions further cause the computer system to automatically notify the recommender of the loan request via the network prior to receiving creditworthiness information from the recommender;

the loan request is received from the user via a communication on the network from a user device, and wherein the initiating of an automatic loan process comprises transmitting an acceptance notice to the user device; and

the loan request is received from the user via a communication on the network from a user device, and wherein the initiating of an automatic loan process comprises transmitting an acceptance notice to the user device, wherein reception of the acceptance notice causes the user device to initiate a loan management function locally on the user device.

In an aspect is a method comprising: receiving, by a server on a network, a loan request from a user, wherein the loan request specifies a plurality of recommenders on the network; receiving, by the server via the network, creditworthiness information for the user from each of the plurality of recommenders; aggregating the obtained creditworthiness information to obtain a creditworthiness rating; and transferring an amount of credit to an account associated with the user and associating a loan term to the transferred credit, the loan term being determined in part by the creditworthiness rating. In embodiments:

the loan request received by the server is transmitted from a user device, and wherein, when the creditworthiness rating meets or exceeds the threshold, the method further comprises: transmitting, by the server via the network, an acceptance notice to the user device; and initiating a loan management function on the server and optionally initiating a loan management function on the user device;

when the creditworthiness rating is below the threshold, the method further comprises transmitting, by the server via the network, a denial notice to the user; and

the loan request received by the server is transmitted from a user device, and wherein the loan request is a structured inquiry comprising a user device identification, the loan request identification, and a recommender identification for each of the plurality of recommenders.

In an aspect is a user interface, the user interface comprising machine-readable instructions such that the user interface is configured to carry out the methods described herein. In an embodiment, the user interface is configured to: prompt a user and receive a loan request from the user; prompt the user and receive a plurality of recommenders from the user, each recommender identified by a unique ID (e.g., a phone number); transmit the loan request including the plurality of recommender IDs to a server via a network; receive a loan decision from the server, the loan decision based on the loan request, the user identity and history where available, and creditworthiness information provided to the server by at least one of the plurality of recommenders; and display the loan decision.

In an aspect is a user interface for a device, the device belonging to a recommender identified by a user in a loan request, the user interface configured to carry out the methods herein. In an embodiment, the user interface is configured to: prompt a recommender and receive creditworthiness about the user from the recommender, wherein the prompting is initiated by receipt of the device of a request for creditworthiness information from a server; and transmit the received creditworthiness information to the server.

These and other aspects of the invention will be apparent to one of skill in the art from the description provided herein, including the examples and claims.

### BRIEF DESCRIPTION OF THE DRAWINGS

FIG. 1 provides a flow chart for a system according to an embodiment as described herein.

FIG. 2 provides a flow chart for a system according to an embodiment as described herein, with a plurality of recommenders shown.

FIG. 3 provides a flow chart for a recommendation scorer module according to an embodiment as described herein.

FIG. 4 provides a representation of a user interface on a user device in the process of requesting a loan according to an embodiment as described herein.

FIG. 5 provides a representation of a user interface on a user device in the process of requesting a loan and specifying recommenders according to an embodiment as described herein.

FIG. 6 provides a representation of a user interface on a user device in the process of receiving a loan approval according to an embodiment as described herein.

FIG. 7 provides a representation of a user interface on a recommender device in the process of requesting a recommendation from the recommender according to an embodiment as described herein.

FIG. 8 provides a representation of a user interface on a recommender device in the process of the recommender providing a recommendation according to an embodiment as described herein.

### DETAILED DESCRIPTION

Throughout this disclosure, references to a mobile phone, unless specified otherwise, are meant to include any mobile device capable of carrying out the telephony function of a mobile phone. Thus, telephony-enabled tablets and other mobile devices (now known or later developed) are meant to be encompassed.

In an aspect is a system and method for determining creditworthiness of a user. The term “user” as used herein refers to any individual wishing to access credit (or, as described herein, other banking services) from a banking institution. The term may be used interchangeably herein with “borrower”.

Throughout this disclosure, a loan and the process of obtaining/granting a loan is used to exemplify the systems and methods disclosed herein. This is done purely for the sake of convenience and such exemplary discussion is not meant to be limiting; other types of banking products can be the subject of the disclosed methods and systems. For example, a user can request to open a savings or checking account, and such request can be treated similarly to a loan request by the system/methods disclosed. Other examples of banking products include investment vehicles and the like. For such embodiments the disclosure provided herein may be modified where necessary (e.g., the information requested of the recommenders may be modified as necessary) to fit the specific banking product. Furthermore, where a loan is requested by the user, the loan can be any type of loan such as a personal loan, a mortgage, a line of credit, a school loan, and the like. All such products are intended to be within the scope of the invention, and again where necessary, the systems and methods may be modified as needed to fit the specific type of banking product.

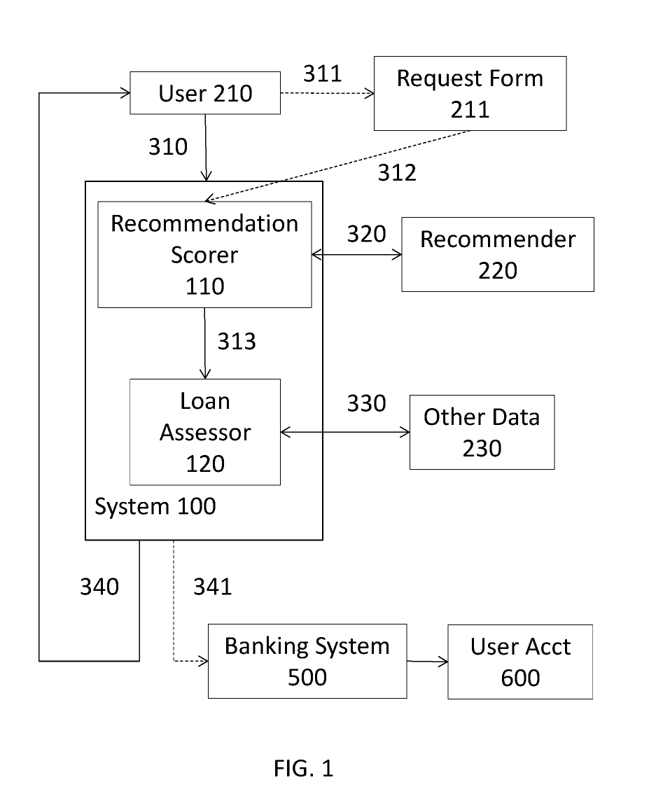

With reference to FIG. 1, various aspects of the systems and methods of the invention will be described. There is shown System 100. System 100 can be, in embodiments, a server on a network. System 100 contains all of the components necessary to carry out the methods disclosed herein. For example, in embodiments, System 100 comprises a processor and a memory coupled to the processor, the memory configured to store program instructions executable by the processor to cause the computer system to carry out the disclosed methods. It will be appreciated that System 100 may comprise a plurality of processors and/or memories, but that such will work together when necessary in order to carry out the disclosed methods. System 100 may further comprise I/O devices such as a monitor, keyboard, mouse, printer, and the like. System 100 may interface with terminals (e.g., via a network) in order to receive input and provide output. Throughout this disclosure it may be said that System 100 comprises various components or modules. Such disclosure is intended to include instances where the various components or modules are physically separate and identifiable (e.g., separate hardware) as well as instances where such components or modules are merely executed as virtual components or modules within the processor and memory of System 100. Aspects of System 100 can be carried out by a localized computer system or, alternatively or in addition, by a delocalized system (i.e., using “cloud computing” principles and methods). Furthermore, System 100 can be a pre-existing banking system used by a banking institution, or can be a dedicated system specifically built and installed in order to carry out the methods described. Where System 100 is a separate system, it will be configured to interface with existing banking systems where applicable. For example, System 100 will be configured to interface with Banking System 500 as described herein.

System 100 may receive direct input from User 210, i.e., via communication 310. User 210 employs a user device (not shown) in order to communicate with System 100 and provide direct input. Such input comprises, in embodiments, a request for a loan as well as a list of recommenders. In embodiments, appropriate input can be obtained by prompting User 210 via a user interface on the user device. For example, the user interface can provide a first menu that allows the user to initiate a loan request process. The loan request selection then takes the user to a second menu where the user is prompted to input a list of recommenders. Other information can be obtained, if necessary, such as the user's desired loan terms (i.e., amount of the loan, repayment time, installment payment amounts, etc.), additional contact information, loan guarantor, and the like. The prompt for inputting recommenders can take any suitable format, such as a request for a telephone number or other identification/contact number, a request for a name, a request for a relationship with the user, or combinations thereof.

Communication 310 includes communications via the network to which System 100 is connected. In embodiments, the network is a cellular network. In such embodiments, User 210 can communicate directly with System 100 via the cellular network, using a mobile user device such as a cellular phone, tablet, or other device that interfaces with a cellular network. Alternatively or in addition, the network can be a fixed line network such as a LAN or WAN, wherein User 210 uses a device on the network such as a personal computer or the like. An example such embodiment involves Communication 310 over the Internet, wherein System 100 is a node on the Internet and User 210 uses a device also connected to the Internet. Combinations of networks are also possible—User 210 can use a device that communicates with a cellular network, while System 100 is connected to a data network that interfaces with the cellular network.

Alternatively or in addition, System 100 may receive indirect input from User 210, i.e., via a Request Form 211. In embodiments, Request Form 211 is a physical (e.g., paper-based) form that is completed (311) by User 210. Request Form 211 contains the same information as described above for direct input—e.g., an option to request a loan, space to list recommenders, and optional additional information such as loan terms, etc. Information provided on Request Form 211 is then captured (312) either by scanning the form and automatically converting the scanned form to usable data, or by manually inputting the data into appropriate fields.

The result of process 310 or of the combination of processes 311 with 312 is a user loan request that is received by System 100. The user loan request identifies the user making the request (e.g., with a phone number, government ID number, bank-issued ID number, or some other form of ID), the fact that the request is for a loan, a list of recommenders, and optionally additional information such as loan terms (amount, repayment terms, requested interest rate, guarantor, etc.).

System 100 receives the user loan request, and in embodiments assigns a unique identifier with the user loan request in order to facilitate further processing. In embodiments, the user loan request is received and processed by Recommendation Scorer 110, a module within System 100. Recommendation Scorer 110 may parse out certain information from the user loan request and transmit such information to other modules within System 100, or may process all of the data received in the user loan request. In embodiments, Recommendation Scorer 110 comprises a database of known recommenders (or is in communication with such a database, if the database is stored elsewhere such as within a different module in System 100 or in an entirely separate system), a database of known users (or is in communication with such a database, if the database is stored elsewhere), and machine-readable instructions to enable determination of a creditworthiness rating, as described herein. Upon receipt of a user loan request, Recommendation Scorer 110 extracts information such as the identity of the user and of the recommenders listed in the user loan request, and attempts to match such identities with known users and recommenders in a database users and a database of recommenders. If no match is found, Recommendation Scorer 110 adds the user and/or recommender to the appropriate database. The user loan request may specify any desired number of recommenders, typically within the range of 1-10 or 1-7 or 2-5 recommenders, such as at least 1, 2, 3, 4, 5, 6, 7, or 8 recommenders. In embodiments, at least 1 recommender is present in a user loan request. In embodiments, at least 2 recommenders are present in a user loan request. In embodiments, at least 3 recommenders are present in a user loan request. In embodiments, User 210 is allowed to rank the indicated recommenders, such as in a preferred order of contact (e.g., contact recommenders A, B, C, D, and E in a specific order until the required number of recommenders has been contacted).

Recommendation Scorer 110 communicates (320) with each Recommender 220 identified in a user loan request in order to receive creditworthiness information from each. In embodiments, communication 320 is via a network such as a cellular network, provided that a phone number is included with each recommender in the user loan request (or a phone number can be identified in the database of recommenders). In embodiments, Communication 320 initiates an application on a recommender's device, and the application prompts the recommender to provide creditworthiness information. In embodiments, Communication 320 involves directly prompting Recommender 220 to provide creditworthiness information. Examples of this direct prompting include USSD and SMS communications between System 100 and the recommender's device. Other methods for receiving creditworthiness information from Recommender 220 include voice calls (particularly automated calls requesting binary input or choice-selection input as described herein) and the like.

Information requested of Recommender 220 constitutes creditworthiness information and can include any combination of the following, or similar: a single numerical rating, a binary rating, an unformatted textual response, and a selection from a number of labelled choices. These options pertain to the creditworthiness of the user as known, understood, expected, or believed by the recommender. The creditworthiness information may be based on the recommender's personal assessment of the user's ability and likelihood to comply with the terms of the loan (e.g., make all payments, and make timely payments, etc.). For example, a single numerical rating may be a rating within a given range such as 1-5 or 1-10 (e.g., with a rating of 1 indicating the lowest possible mark, and a rating of 5 or 10 indicating the highest possible mark). For example, a binary rating may be a yes/no answer to a question posed to the recommender (e.g., “Do you recommend that we make a loan to the user?”). For example, an unformatted textual response may pose an open-ended question to the recommender, allowing the recommender to provide narrative regarding the creditworthiness of the user. For example, a selection from a number of labelled choices may involve posing to the recommender a list of options (e.g., a list of four options may read: “1. I recommend this user unconditionally; 2. I recommend this user with minor reservations; 3. Loans should be made to this user only with caution; or 4. I do not recommend that this user receive a loan”). Combinations and/or multiples of the above information can be requested of the recommender. For example, a series of yes/no questions can be posed to the recommender in order to obtain maximally useful creditworthiness information that. Furthermore, where multiple answers are requested of the recommender, the system can be designed to allow for adaptive responses in the questions posed (i.e., the answer to one question may alter the content of subsequent questions). In embodiments, the above-described questions enable automatic processing of the creditworthiness information. The prompting of the recommender may also include an option to indicate that the user is unknown to the recommender, or that the user is not known well enough to the recommender for the recommender to provide creditworthiness information.

The Recommendation Scorer 110 receives creditworthiness information from each Recommender 220 (or from a subset, for example, if some recommenders respond that the user is unknown to them). In embodiments the Recommendation Scorer 110 stores (or causes to be stored, if remote storage is used) the received creditworthiness information, associating it with the relevant user loan request. The Recommendation Scorer 110 also processes the received creditworthiness information, such as by applying an algorithm as described herein, in order to obtain a creditworthiness rating. The creditworthiness rating, in embodiments, is a numerical value that may be selected from a scale (e.g., ranging from 1-5, or 1-10, or 1-100, or some other convenient range, where lower numbers indicate a higher credit risk). In embodiments, the creditworthiness rating is directly communicated (313) to the Loan Assessor 120, a module of System 100.

An algorithm is used by Recommendation Scorer 110 to calculate the creditworthiness rating. In embodiments, the algorithm receives scores from a plurality of recommenders, weights each recommender score (e.g., according to a recommender rating as described herein), and averages the weighted recommender scores. Other algorithms will be suitable and are within the scope of the invention.

Loan Assessor 120 receives the calculated creditworthiness rating from Recommendation Scorer 110 and then compares the creditworthiness rating against a selected threshold. Where the creditworthiness rating exceeds the threshold (assuming that the convention is chosen that a lower rating indicates a higher credit risk), the Loan Assessor 120 uses the creditworthiness rating as a positive factor in determining whether to grant the loan request. Comparison of the creditworthiness rating against a threshold can also be carried out by the Recommendation Scorer module (110), and the result communicated (313) to Loan Assessor 120. The threshold value can be selected and set automatically or manually depending on a variety of factors (e.g., the bank's ability to tolerate risk, the lending environment, etc.), which may vary from user to user as desired.

In embodiments, the creditworthiness rating is a default predictor—e.g., a value within the range of 0-1 that predicts the likelihood of a default by the user on a hypothetical loan.

Loan Assessor 120 further optionally receives Other Data 230. The types of information that may be part of Other Data 230 include: creditworthiness assessments/data or other personal characteristics from private companies (e.g., telecommunications companies, utility companies, property management companies, and the like, each providing payment histories, usage data, etc.); creditworthiness assessments or data from other banking institutions or credit bureaus representing the banking industry; creditworthiness assessments or data from government institutions (e.g., government-sponsored school loan centres, government-provided healthcare repayment information, public library usage and compliance with book return policies, etc.); and social network assessments/data (e.g., mentions of and discussions with the user on social networking sites). The Loan Assessor 120 receives such other data, ensures that it is correctly associated with the user loan request (i.e., that the other data pertains to the same user), and applies a suitable algorithm in order to obtain a loan decision. The algorithm will, in embodiments, use the Creditworthiness rating (or, in embodiments, the binary value indicating whether the creditworthiness rating exceeded the selected threshold) as well as the received other data as inputs, and will provide the loan decision as output. The loan decision comprises a binary value (yes/no) indicating whether the loan is granted, as well as other information such as the loan amount, interest rate, repayment schedule, type of loan, etc.

In embodiments, the loan decision is communicated (340) to User 210 directly and automatically by System 100. In embodiments, such communication is via the same network as the communication 310 of the user loan request to System 100. For example, the user loan request may be communicated (310) via a cellular network, with User 210 using a mobile device to send the user loan request. Then, System 100 returns a loan decision via the same cellular network and to the same mobile device of User 210. In this way, an automated system for receiving a loan request and providing a loan decision is provided by the methods and systems described herein.

Where the loan decision is to grant the loan, such information can be made known (i.e., transmitted) to the system(s) capable of transferring funds and maintaining/monitoring the progress of a loan. The system capable of transferring funds may, in embodiments, be a banking system that is separate from System 100 (although in other embodiments such systems may be the same system). Accordingly, depending on the loan decision, and in addition to communicating with User 210, System 100 further optionally interfaces with Banking System 500 via communication 341. Such interface and communication includes initiating, by System 100, a banking process (i.e., a loan process) carried out by Banking System 500. The banking process may comprise the granting, processing, and recording of a loan, in which case the process is mediated by the loan terms determined by System 100. In embodiments the banking process is carried out automatically (although allowing for human intervention where desired). Thus in embodiments System 100 initiates an automatic loan process with a loan factor that is determined at least in part by the creditworthiness factor as determined herein. In embodiments banking system 500 interacts with a user account 600, which is an account held by User 210 such as a mobile money account linked to the phone number of User 210, a bank account belonging to User 210, or the like. Accordingly, in embodiments, the method involves automatically (based on a determined creditworthiness score and the corresponding loan decision) instructing a banking system to directly deposit funds to a user account.

Furthermore when the loan decision is to grant the loan, an acceptance notice can be sent to the user device (e.g., communication 340 in FIG. 1) and other procedures or changes to the server and/or user device can be initiated in order to manage the new loan. For example, the user device can be prompted to download loan management software (or such download can be initiated automatically). The user device initiating the loan may, however, be incapable of supporting loan management software, in which case all loan management activities (e.g., reminders for repayments, updates to the loan amount due to payments received, etc.) are maintained and managed by the server. In some such cases communications with the user device continue throughout the life of the new loan (e.g., as the loan balance reduces due to payments made, or as the loan goes into default, etc.), using any means available based on the specific user device (e.g., USSD, SMS, etc.).

When the loan decision is to reject the loan, a denial notice can be sent to the user device (again, e.g., communication 340). Such denial notice may optionally include reasons for the denial or other information that the lender wishes to relay to the user.

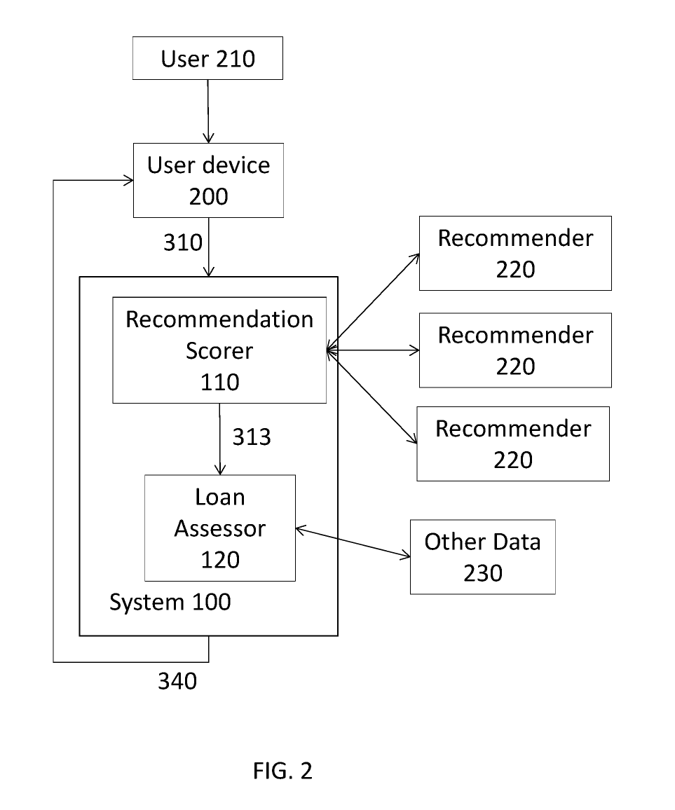

With reference to FIG. 2, a version of the process flow described above is provided. Specifically, user 210 requests a loan via user device 200, which communicates with system 100 as described herein. System 100 receives creditworthiness information from recommender 220 (three separate recommenders are shown in FIG. 2).

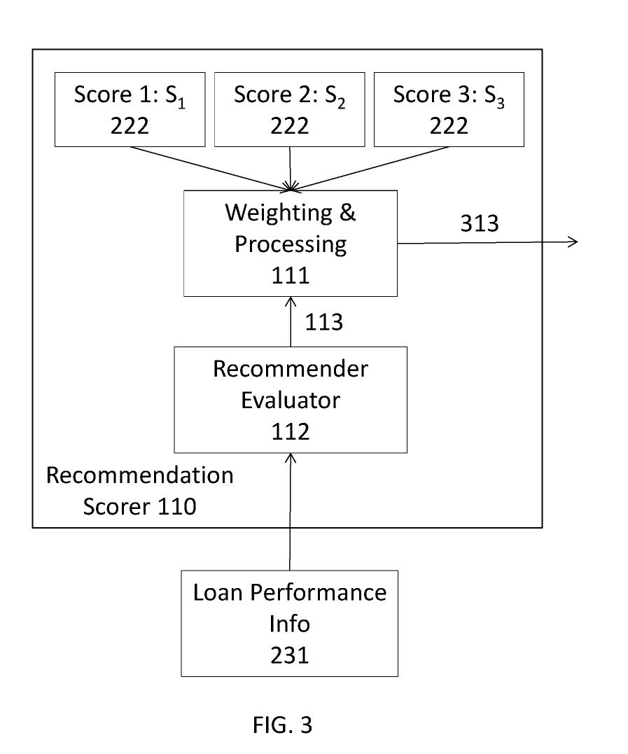

With reference to FIG. 3, the workings of Recommendation Scorer 110 are provided in more detail. External information such as loan performance info 231 may be provided to recommender evaluator module 112 of recommendation scorer 110. Recommender evaluator 112 receives the loan performance information and produces a series of n ratings ({Rᵣ₁, Rᵣ₂ . . . Rᵣₙ}) for the n recommenders that transmit creditworthiness information to system 100 as a result of being nominated by user 210. Weighting and processing module 111 receives the ratings from recommender evaluator 112 and the creditworthiness information from the various recommenders (labelled 222 and shown in FIG. 3 as Scores S₁, S₂, and S₃). These values are combined to form a Creditworthiness rating via a weighting scheme such as the following equation:

$$creditworthiness rating = \frac{{\sum }_{i = 1}^{n} {R}_{ri} * {S}_{i}}{{\sum }_{i = 1}^{n} {R}_{ri}}$$

The creditworthiness rating is communicated 313 to the loan assessor (not shown in FIG. 3).

In some embodiments, the user interface provided on the user device (which, again, may be a dedicated application stored locally on the device or may be a sequence of USSD or SMS messages) may allow the user to alter or augment the initial loan application. For example, where the initial loan application is rejected due to a determined creditworthiness rating that falls below the selected threshold, the user interface may present the denial notice and then further options such as allowing the user to submit additional recommenders, or to change the requested loan terms (e.g., reduce the amount of credit requested in the loan, or alter the terms of the requested loan such as the repayment schedule, etc.). All such interactions are conveniently moderated by a dedicated application but may alternatively be implemented via USSD, SMS, or other functions found on basic mobile phones. In some embodiments, user input during the loan application phase (e.g., either directly in the loan request or received by the server after initial receipt of the loan request) alters the operation/status of the server. For example, if the loan request specifies a loan amount that exceeds a pre-determined threshold, the server can respond by requesting from the user supplementary recommenders (e.g. a number of recommenders beyond a standard number of recommenders used for smaller loan amounts) or specification of collateral for the loan. Also for example, if the loan request specifies one or more recommenders not known to the system (e.g., not in the recommender database as mentioned herein), the system can return to the user a request for additional recommenders. Such interactions can proceed until such time as the system has received a compliant loan request (i.e., a loan request with adequate recommenders and other details in order to be processed).

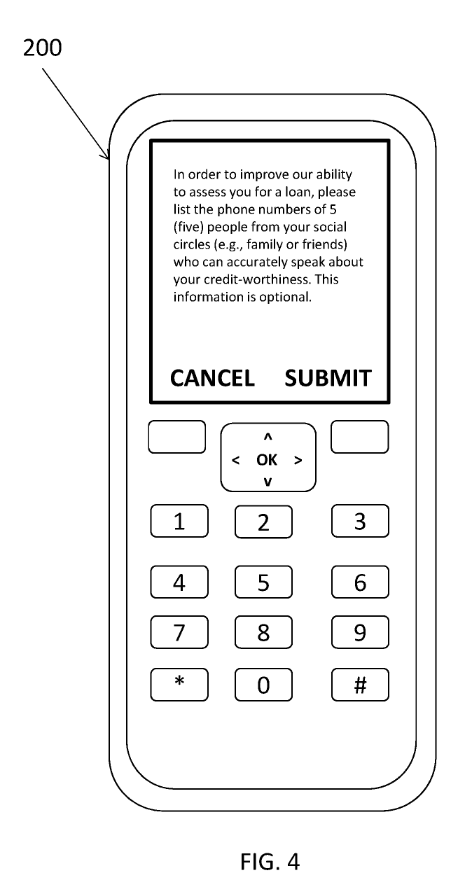

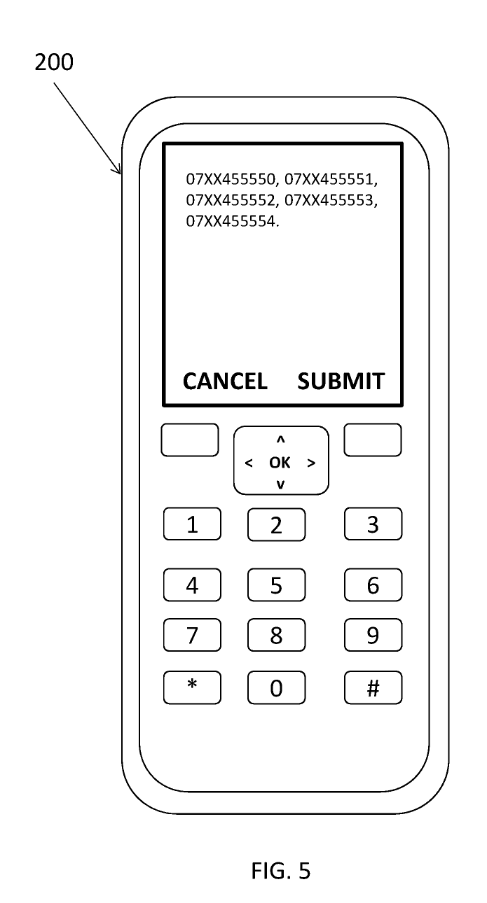

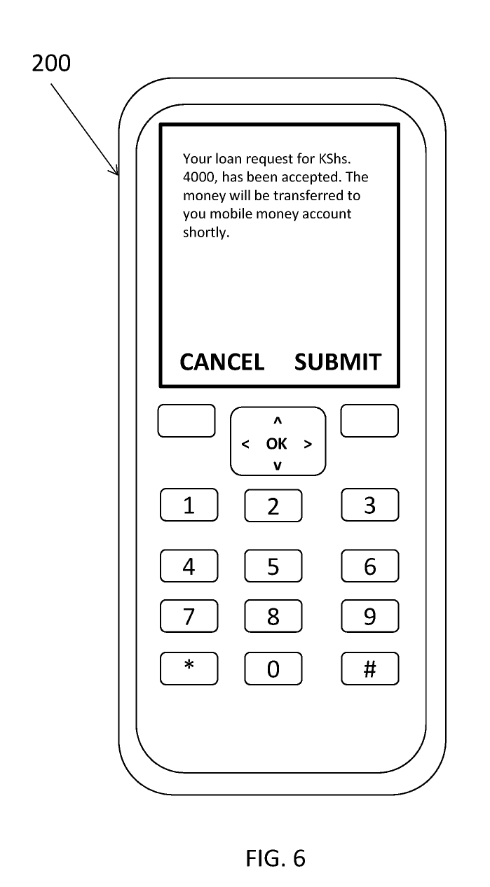

With reference to FIGS. 4-6, a series of user interface images on user device 200 are shown. The initial image, shown in FIG. 4, provides instructions to a user requesting a loan (this screen would appear after a user initiates the loan process from, e.g., a home page of the user interface). The instructions instruct the user to input five phone numbers corresponding to five recommenders from which creditworthiness information is to be obtained. FIG. 5 shows the user interface after the user has input the five phone numbers. FIG. 6 shows the response sent to user device 200 after the system has determined a creditworthiness score and determined a loan decision (in the specific image of FIG. 6, the loan decision is an approval).

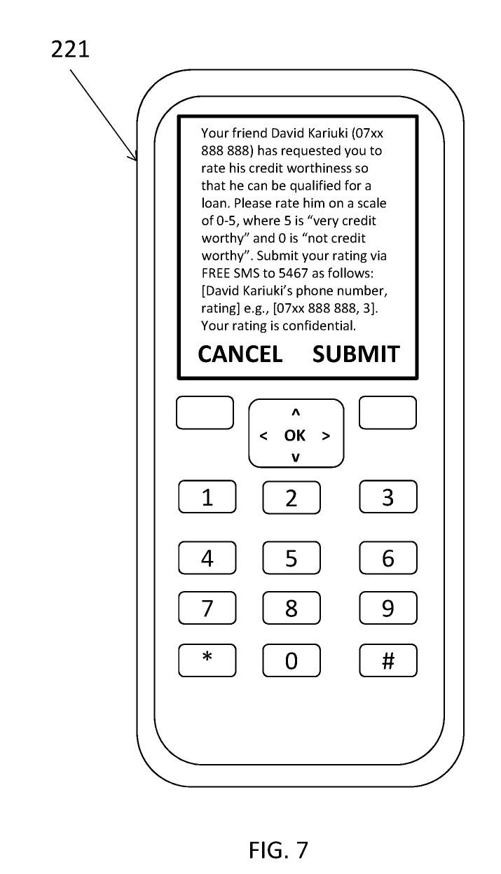

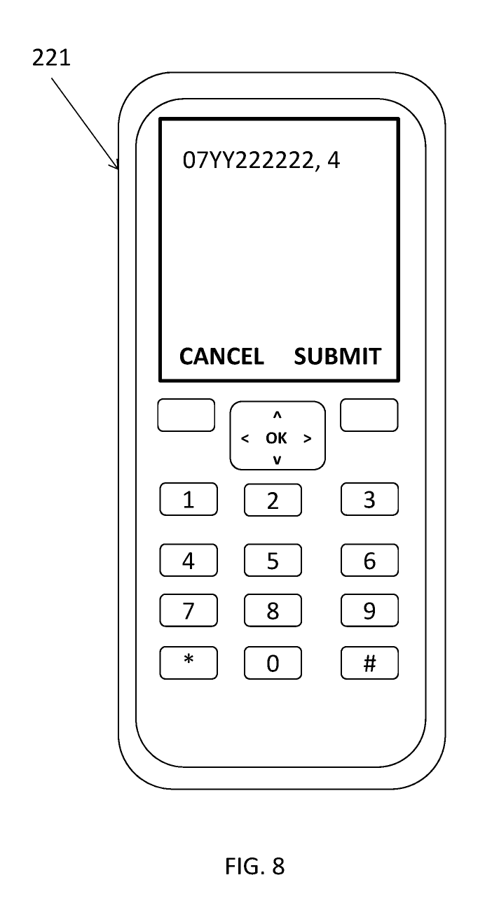

With reference to FIGS. 7-8, a series of user interface images on recommender device 221 (i.e., a device belonging to a recommender) are shown. The initial image, shown in FIG. 7, instructs the recommender to provide a recommendation for the user. The instructions may provide the desired format of the recommendation and creditworthiness information, and may inform the recommender that the rating is confidential and will not be shared with the user requesting the recommendation. FIG. 8, then, shows the input from a recommender as formatted according to the instructions provided.

The systems and methods described herein are influenced by the creditworthiness information provided by recommenders (which recommenders are identified in the user loan request, and which creditworthiness information is used to calculate a creditworthiness rating). Such influence includes using the creditworthiness rating to determine a loan factor. The process of granting and making a loan involves determining a variety of factors, including the amount of the loan (principal), the rate of interest, repayment schedules (e.g., the loan term in number of years or months, the number and frequency of payments, etc.), nature of the loan (e.g., whether a line of credit, a strictly declining balance loan, or another type of loan, as well as collateral is required), and the like. The creditworthiness rating can, in embodiments, be used to determine or modify any such factor. For example, System 100 may be configured to determine a loan amount that is proportional to the initial loan request and to the creditworthiness rating. As another example, System 100 may be configured to determine a loan interest rate that is proportional to the creditworthiness rating. Other examples are possible and will be apparent to one of ordinary skill. In conjunction with the ability of System 100 to initiate a loan process, it can therefore be said that the systems described herein enable a loan process to be initiated, mediated, and modified by recommendations received from the recommenders described herein.

As mentioned herein System 100 may contain a recommender database. This is a database of all known recommenders (e.g., known from previous user loan requests, etc.) and their contact information. Each recommender may be associated with an identification number (e.g., a phone number or an assigned ID) and, optionally, further information selected from a recommender tally and a recommender rating. In embodiments, a recommender tally is an integer that is used to track the number of times a recommender has provided creditworthiness information. The system deducts from the tally every time that a recommender provides creditworthiness, such that a recommender's ability to provide a recommendation is a scarce resource. The system can optionally include mechanisms that allow a recommender to increase their recommender tally, such as a reward system. In embodiments, a recommender rating is a numerical value that indicates the trustworthiness of a recommender. The recommender rating can be calculated based on a plurality of data, such as the recommender's credit score (i.e., from an independent credit bureau), the number of times that a recommender has provided creditworthiness information for a user where such information was later found to accurately predict the user's performance in servicing (i.e., timely repaying) a granted loan, the number of times that a recommender has provided creditworthiness information for a user where such information was later found to be inaccurate in predicting the user's performance in servicing (i.e., timely repaying) a granted loan, and the like. The recommender rating is, in itself, a form of credit score, and can be used by System 100 (or other systems able to access the rating) when the recommender becomes a user—i.e., when the recommender requests a banking service. The above description of a recommender tally and recommender rating describe mechanisms for incentivising accurate creditworthiness information as provided by recommenders. False or fraudulent creditworthiness information is discouraged, and accurate or objective information is encouraged. Financial rewards and other tangible rewards can be used to reward recommenders with high ratings or tallies, and/or for recommenders providing creditworthiness information for users that make payments on time and do not default on a loan. Improved credit ratings and lower interest on loans are other incentives that can be used to encourage accurate information from recommenders. In some embodiments, any late payment or default by a user can negatively affect the recommenders that provided creditworthiness information for the user. Such consequences can include reduction in recommender tallies or ratings, financial penalties, or the like. It will be appreciated that, when a recommender is first encountered (e.g., due to being nominated in a user loan request) by System 100, the recommender has no recommender rating. A default rating can be applied, and the default rating can be modified by any available information about the recommender such as a formal credit score.

In embodiments, the creditworthiness information provided by recommenders can be weighted based on the history of the user, and can be reduced in importance over time as a user gains formal credit history. Thus the creditworthiness rating can be weighted by Loan Assessor 120 based on the amount of formal data (e.g., historical data on loan repayment) that is available for the user.

In embodiments, a graph of recommenders can be constructed, with the chronologically recent recommendations being the leaves, and the oldest recommendations being closer and closer to the seed recommendation. In an embodiment, the root and top-level branches of the tree benefit or are hurt by all subsequent loan performance activities of the children recommendations.

In embodiments, the methods and systems herein learn from the performance of the graph or tree of recommendations created over time and dynamically updates the recommender ratings.

In embodiments is a method and system by which basic GSM mobile phone capabilities, specifically USSD (Unstructured Supplementary Service Data), SMS (Short Message Service) and STK (SIM Application Toolkit), smart-phones, computer devices, and manual systems, can be used to implement a creditworthiness recommendation system based on social capital (i.e., social interactions, reputations, etc.). Such devices can be user devices for the user (i.e., the user requesting a loan) as well as for the recommenders, and user devices can be different for each such entity. The method and system provides an improved accuracy of creditworthiness assessment for people who have no formal credit history by using quantized, truth-buoyed recommendations from recommenders, some of whom may have formal credit history. In embodiments is a method that collects a recommender's evaluation of the credit worthiness of a user, as a discrete unit along a parameterized spectrum, and transmits that evaluation into a loan processing system (whether as part of the recommending system or as a separate system). Weighted recommendations are used to determine a credit risk (i.e., a creditworthiness rating) for a user. Also in embodiments is a method that weighs the importance of the recommender's creditworthiness information based on the recommender's own reputation-based rating. In embodiments is a method that progressively attaches greater importance to the user's new or recent recorded transactions, as it simultaneously decays the importance of the creditworthiness information over time. In embodiments is a method and system that learns from the performance of a graph or tree of recommendations created over time and dynamically updates the recommender ratings as appropriate.

Advantages of the system include, for the user, an opportunity for inclusion into formal credit-worthiness without prior formal financial history. For the recommender, advantages include social capital from service rendered to the user, and may further include optional monetary rewards from the lender. For the lender, advantages include richer customer insight, and in-built protection from fraud via disincentives.

The advantages are particularly beneficial for low-income sectors, where formal credit histories are typically not available or provide an incomplete picture of a user's creditworthiness. In such cases, even proxy values (e.g., the number of mobile money transactions carried out by a user) may be inaccurate, and such users can benefit from additional information regarding their creditworthiness. New credit products that target low-income and informal economic sectors will further benefit, as such commonly allow determination of creditworthiness from non-traditional data. These products may be micro, instantaneous, and use different data sources (e.g., calling behavior). For people that don't have any calling history behavior or some other indicator of credit worthiness, no bank accounts, etc., such people may have more traditional indicators of worthiness that are not measurable in digital format (e.g., reputations). The systems and methods described herein enable capture of such data and are an additional tool to help banking institutions effectively deliver such products.

Throughout this disclosure, use of the term “server” is meant to include any computer system containing a processor and memory, and capable of containing or accessing computer instructions suitable for instructing the processor to carry out any of the steps disclosed herein or otherwise necessary to achieve the desired operation. The server may be a traditional server, a desktop computer, a laptop, or in some cases and where appropriate, a tablet or mobile phone. The server may also be a virtual server, wherein the processor and memory are cloud-based—i.e., decentralized processing and storage.

The methods and devices described herein include a memory coupled to the processor. Herein, the memory is a computer-readable non-transitory storage medium or media, which may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Throughout this disclosure, use of the term “or” is inclusive and not exclusive, unless otherwise indicated expressly or by context. Therefore, herein, “A or B” means “A, B, or both,” unless expressly indicated otherwise or indicated otherwise by context. Moreover, “and” is both joint and several, unless otherwise indicated expressly or by context. Therefore, herein, “A and B” means “A and B, jointly or severally,” unless expressly indicated otherwise or indicated otherwise by context.

It is to be understood that while the invention has been described in conjunction with examples of specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. The pertinent parts of all publications mentioned herein are incorporated by reference. All combinations of the embodiments described herein are intended to be part of the invention, as if such combinations had been laboriously set forth in this disclosure.

### EXAMPLES

### Example 1

A system was prepared that allowed the following process steps. The user requests a loan and specifies recommenders. The loan processor system requests each of the recommenders to rate the borrower on a scale, such as a scale of 1-5. The recommenders submit a rating for the borrower. The recommendation scorer computes a score/rating based on the ratings submitted by all the recommenders. The creditworthiness rating is submitted into the loan assessment system for consideration with other factors. The user then receives a response to their loan request.

### Example 2

A system according to the invention contained a recommendation scorer with machine instructions to calculate a creditworthiness rating from a plurality of recommender input (creditworthiness information). The Recommendation Scorer receives scores S₁, S₂ . . . Sₙ from “n” recommenders. Each score is a numerical value within the range 1-10. The recommender rating “R” for each recommender is extracted from a recommender database. If a recommender from the n recommenders is not in the recommender database, he/she is added to the database and given a starting rating. A creditworthiness rating is then calculated using the following equation:

$$creditworthiness rating = \frac{{\sum }_{i = 1}^{n} {R}_{ri} * {S}_{i}}{{\sum }_{i = 1}^{n} {R}_{ri}}$$

The creditworthiness rating is then passed to the Loan Assessor for comparison with a threshold and evaluation along with other data.

What is claimed is:

1. A method comprising:
receiving, by a server on a network, a user loan request, wherein the loan request specifies a recommender on the network;
receiving, by the server via the network, creditworthiness information for the user from the recommender;
determining a creditworthiness rating for the user based on the obtained creditworthiness information;
comparing the creditworthiness rating to a threshold; and
initiating an automatic loan process using the creditworthiness rating to determine at least in part a loan factor when the creditworthiness rating meets or exceeds the threshold.

2. The method of claim 1, wherein the network comprises a cellular network and wherein the user loan request is generated by a user device configured to communicate with the cellular network.

3. The method of claim 1, wherein the method further comprises automatically notifying the recommender of the loan request via the network prior to receiving creditworthiness information from the recommender.

4. The method of claim 1, wherein the method further comprises automatically notifying the recommender of the loan request and further comprises prompting the recommender to facilitate entry of creditworthiness information by the recommender.

5. The method of claim 1, wherein the creditworthiness information comprises information selected from loan repayment history, character reference, and repayment capacity.

6. The method of claim 1, wherein the creditworthiness information is selected from a single numerical rating, a binary rating, an unformatted textual response, and a selection from a number of labeled choices.

7. The method of claim 1, wherein the creditworthiness information received by the server is transmitted by the recommender from a mobile phone.

8. The method of claim 1, wherein the determined creditworthiness rating is based in part on a plurality of obtained creditworthiness information received from a plurality of recommenders, and in part on a stored credit history of the user.

9. The method of claim 1, wherein the initiating an automatic loan process comprises instructing an automated loan system to process a loan request and transfer funds.

10. The method of claim 1, wherein the loan factor is selected from a loan amount, an interest rate, and a repayment schedule.

11. The method of claim 1, wherein the loan request specifies a plurality of recommenders on the network and wherein the method further comprises receiving, by the server via the network, creditworthiness information for the user from each of the plurality of recommenders.

12. The method of claim 1, wherein the method further comprises assigning a score to the recommender, wherein the score is dynamically updated based on a user performance factor over time.

13. The method of claim 1, wherein the method further comprises assigning a tally to the recommender, and wherein receiving creditworthiness information for the user from the recommender results in a reduction in the tally of the recommender.

14. The method of claim 1, wherein the method further comprises digitally constructing a hierarchical structure comprising the recommender and optionally a plurality of additional recommenders, wherein each recommender is assigned a tally, and wherein the method further comprises relating the hierarchical structure to the user, and further comprises altering a tally for a recommender within the hierarchical structure based on a user performance factor.

15. The method of claim 1, wherein the network comprises a cellular network and wherein the user loan request is generated by a user device configured to communicate with the cellular network, and wherein the loan request specifies a plurality of recommenders on the network and wherein the method further comprises receiving, by the server via the network, creditworthiness information for the user from each of the plurality of recommenders.

16. A system comprising a server, the server comprising a processor and a memory coupled to the processor, the memory configured to store program instructions executable by the processor to cause the computer system to:
receive a loan request from a user, wherein the loan request specifies a recommender on a network;
receive creditworthiness information for the user from the recommender;
determine the users creditworthiness based on the obtained creditworthiness information;
compare the creditworthiness rating to a threshold; and
initiate an automatic loan process using the user's creditworthiness rating to determine a loan factor when the creditworthiness rating meets or exceeds the threshold.

17. The system of claim 16, wherein the creditworthiness information received by the server is transmitted by the recommender from a mobile phone using USSD, STK, SMS, or a dedicated application on the mobile phone.

18. The system of claim 16, wherein the network comprises a cellular network and the user loan request is generated by a user device configured to communicate with the cellular network, and wherein the loan request specifies a plurality of recommenders on the network and the system is further configured to receive, by the server via the network, creditworthiness information for the user from each of the plurality of recommenders.

19. The system of claim 16, wherein the program instructions further cause the computer system to automatically notify the recommender of the loan request via the network prior to receiving creditworthiness information from the recommender.

20. The system of claim 16, wherein the loan request is received from the user via a communication on the network from a user device, and wherein the initiating of an automatic loan process comprises transmitting an acceptance notice to the user device.

21. The system of claim 16, wherein the loan request is received from the user via a communication on the network from a user device, and wherein the initiating of an automatic loan process comprises transmitting an acceptance notice to the user device, wherein reception of the acceptance notice causes the user device to initiate a loan management function locally on the user device.

22. A method comprising:
receiving, by a server on a network, a loan request from a user, wherein the loan request specifies a plurality of recommenders on the network;
receiving, by the server via the network, creditworthiness information for the user from each of the plurality of recommenders;
aggregating the obtained creditworthiness information to obtain a creditworthiness rating, and comparing the creditworthiness rating to a threshold; and
transferring, when the creditworthiness rating meets or exceeds the threshold, an amount of credit to an account associated with the user and associating a loan term to the transferred credit, the loan term being determined in part by the creditworthiness rating.

23. The method of claim 22, wherein the loan request received by the server is transmitted from a user device, and wherein, when the creditworthiness rating meets or exceeds the threshold, the method further comprises:
transmitting, by the server via the network, an acceptance notice to the user device; and
initiating a loan management function on the server and optionally initiating a loan management function on the user device.

24. The method of claim 22, wherein the loan request received by the server is transmitted from a user device, and wherein the loan request is a structured inquiry comprising a user device identification, the loan request identification, and a recommender identification for each of the plurality of recommenders.

25. A user interface comprising machine-readable instructions such that the user interface is configured to:
prompt a user and receive a loan request from the user;
prompt the user and receive a plurality of recommenders from the user, each recommender identified by a unique ID;
transmit the loan request including the plurality of recommender IDs to a server via a network;
receive a loan decision from the server, the loan decision based on the loan request, the user identity and history where available, and creditworthiness information provided to the server by at least one of the plurality of recommenders; and
display the loan decision.
